(19) United States
(12) Patent Application Publication
(10) Pub. No.: US 2007/0256708 A1
(43) Pub. Date: Nov. 8, 2007

(54) Dishwasher Comprising Automatically Cleaning Washing Liquid Lines

(75) Inventors: Michael Rosenbauer, Reimlingen (DE); Bernd Schessl, Dillingen/Donau (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/587,026

(22) PCT Filed: Apr. 21, 2005
(86) PCT No.: PCT/EP05/51767

§ 371 Date: Jun. 22, 2007

(30) Foreign Application Priority Data
Apr. 21, 2004 (DE) 10 2004 019 334.7

(51) Int. Cl. B08B 3/02

(52) U.S. Cl. 134/18; 134/198; 134/56 D

(57) ABSTRACT

A dishwasher is provided, wherein the protruding wash residues can be automatically cleaned in the most efficient manner possible in the washing liquid lines, in order to maintain the cleaning effect of the washing device. The dishwasher comprises at least one washing compartment, and a washing device that is used to spray the liquid into the inner chamber of the washing container, in addition to at least one washing liquid line which is used to supply the liquid to the cleaning device. The washing liquid line comprises at least one first opening and one second opening that is arranged at a distance from the first opening, over which the respective alternative cleaning liquid can be supplied in a pressurized manner.

The invention relates to a dishwasher comprising washing liquid lines for conveying washing liquid to spray devices for spraying washing liquid onto items to be washed and in particular a method for self-cleaning of washing liquid lines in dishwashers.

Dishwashers with spray devices are known wherein the washing liquid is sprayed onto the items to be cleaned during the washing mode by means of spray devices, such as rotating spray arms, for example. For this purpose, the washing liquid is supplied to the rotating spray arms by a circulating pump via washing liquid lines and the liquid emerges under pressure from spray nozzles and impinges upon the items to be washed. In conventional dishwashers the circulating pump can usually only be operated in one direction of rotation so that the washing liquid only flows in one direction through the washing liquid lines and the spray device. The washing liquid circulated during the washing mode also entrains wash residues which can be deposited in the washing liquid lines and in the spray devices, which can hinder the flow of washing liquid to the extent of causing blockages of the washing liquid lines and spray devices.

Known from DE 197 02 982 is a dishwasher wherein during the washing mode washing liquid is pumped into rotating spray arms via washing liquid lines by a circulating pump. During a pumping-out mode the washing liquid is conveyed from the dishwasher by a drain pump, the circulating pump being temporarily operated in the opposite direction of rotation in order to completely extract the washing liquid from the washing liquid lines and the spray arms. This dishwasher has the disadvantage that during the pumping-out mode washing liquid is merely removed from the washing liquid lines and the spray arms without achieving any cleaning effect in the washing liquid lines.

It is therefore the object of the present invention to provide a dishwasher with a spray device for acting upon items to be washed with washing liquid, wherein wash residues can be automatically cleaned as efficiently as possible from washing liquid lines in order to maintain the cleaning action of the spray arms. It is further the object of the invention to provide a method for operating a dishwasher having the aforesaid properties whereby wash residues can be automatically cleaned as efficiently as possible from washing liquid lines in order to maintain the cleaning action of the spray arms.

These objects are achieved by the dishwasher according to the invention having the features according to claim 1 as well as by a method for operating a dishwasher as specified in claim 10. Advantageous further developments are each characterised in the dependent claims 2 to 9 and 11 to 15.

The dishwasher according to the invention comprises at least one washing container, a spray device for spraying washing liquid into the interior of the washing container and at least one washing liquid line for supplying washing liquid to the spray device, the washing liquid line comprising at least one first opening and a second opening at a distance therefrom, via which washing liquid can be supplied alternately under pressure.

Since in the dishwasher according to the invention, two openings are provided in the washing liquid line for supplying washing liquid, the washing liquid can be supplied under pressure either via one or via the other opening of the washing liquid line. As a result, washing liquid does not always flow under pressure through the washing liquid line in the same direction but at least temporarily in the opposite direction. The alternating direction of flow of the washing liquid in the washing liquid line efficiently and automatically cleans wash residues from the washing liquid line so that the flow of washing liquid is not hindered by wash residues and thus the overall cleaning action of the spray device is maintained. In this way, the washing liquid lines are freed from wash residues in a type of self-cleaning process.

In a preferred embodiment of the dishwasher according to the invention, the washing liquid line has two open ends in each case so that the washing liquid can either be supplied under pressure from one or from the other side, thereby achieving a flow of liquid through the washing liquid line in different directions. During the washing mode, the washing liquid is supplied through one open end of the washing liquid line and further to the spray device of the dishwasher whereas during the self-cleaning process the washing liquid is supplied through the other open end of the washing liquid line, whereby the washing liquid is preferably removed from the spray device of the dishwasher.

According to a further preferred embodiment of the dishwasher according to the invention, the washing liquid line has a number of openings for supplying washing liquid under pressure. As a result of the arrangement of a number of openings along the washing liquid line for supplying washing liquid under pressure, the washing liquid line can be divided into a plurality of sections through which washing liquid can flow either in one or in the other direction as a result of a corresponding choice of openings for supplying washing liquid under pressure. In this way, in particular those sections of the washing liquid line which are particularly susceptible to the deposition of wash residues, can be subjected to a self-cleaning process.

Appropriately provided at least in the dishwasher according to the invention is at least one water diverter which regulates the supply of washing liquid to the washing liquid line. For this purpose, for example, in a first position of the water diverter, the washing liquid is supplied under pressure via the first opening of the washing liquid line and in a second position of the water diverter, the washing liquid is supplied under pressure via the second opening of the washing liquid line. Optionally, the water diverter thereby also regulates the pressure build-up and the pressure reduction of the washing liquid supplied to the washing liquid line. The pressure build-up and the pressure reduction of the washing liquid supplied to the washing liquid line can take place, for example, in a pulsed mode in order to remove wash residues from the washing liquid line as efficiently as possible.

In a further preferred embodiment of the dishwasher, a water diverter is provided at the first opening of the washing liquid line and respectively one water diverter or a valve is provided at the second opening of the washing liquid line, which regulate the supply of washing liquid to the washing liquid line. In this way, washing liquid can be supplied under pressure independently to the two openings in the washing liquid line.

It is particularly advantageous if the pressure at which the washing liquid is supplied to the washing liquid line can be varied. As a result, the washing liquid lines can be automatically cleaned in a self-cleaning process by alternating exposure to washing liquid as required at higher or lower pressure.

The washing liquid is appropriately supplied to the spray channel by a pump device, in particular by the circulating pump of the dishwasher. According to a further preferred embodiment of the dishwasher, the speed or pumping capacity of the circulating pump can be varied. As a result of the variability of the speed and therefore the pumping capacity of the circulating pump, the intensity of the spray jets emerging from the spray device can also be varied.

According to a particularly advantageous embodiment of the dishwasher according to the invention, the washing liquid is supplied under pressure to the washing liquid line by means of a circulating pump which can be operated in opposite directions of rotation. By means of corresponding settings of the valves or water diverters, the washing liquid can then be supplied under pressure to the washing liquid line through the first opening or via the open end when the circulating pump is operated in one direction of rotation and through the second opening or via the other open end when the circulating pump is operated in the opposite direction of rotation.

The aforesaid objects are also achieved according to the present invention by a method for operating a dishwasher at least comprising the following steps:
supplying washing liquid under pressure to a washing liquid line via a first opening in the washing liquid line during a washing mode of the dishwasher,
supplying washing liquid under pressure to a washing liquid line via a second opening in the washing liquid line during a self-cleaning mode of the dishwasher.

As a result of washing liquid being supplied under pressure and acting upon the washing liquid line either via one opening or via the other opening in the washing liquid line, washing liquid does not always flow through the washing liquid line in the same direction but during the self-cleaning process washing liquid also flows in the opposite direction. The alternating direction of flow of the washing liquid in the washing liquid line automatically cleans wash residues from the washing liquid line during the self-cleaning process so that the flow of washing liquid is not hindered by wash residues and thus the overall cleaning action of the spray device is maintained.

In a preferred embodiment of the method according to the invention, the washing liquid is supplied under pressure to the washing liquid line during the washing mode by means of a water diverter via the first opening in the washing liquid line by bringing the water diverter into a first position, the washing liquid being guided further to the spray device by the washing liquid line; during the self-cleaning mode, however, the washing liquid is supplied under pressure to the washing liquid line via the second opening in the washing liquid line, by bringing the water diverter into a second position. It is also possible that the water diverter is embodied in such a manner that it can be varied between the first and the second position in a periodic to-and-fro movement. The periodic to-and-fro movement of the water diverter also alternately changes the direction of flow of the washing liquid in the washing liquid line.

The washing liquid is appropriately supplied via the water diverter in each case through the open ends of the washing liquid line, so that the washing liquid is supplied under pressure to the washing liquid line during the washing mode via one open end of the washing liquid line when the water diverter is in the first position, the washing liquid then being further guided to the spray device of the dishwasher by the washing liquid line. During the self-cleaning mode the washing liquid is supplied under pressure to the washing liquid line via the other open end of the washing liquid line when the water diverter is in the second position, the washing liquid being removed from the spray device of the dishwasher.

In a further preferred embodiment of the method according to the invention, the washing liquid is supplied under pressure to the washing liquid line by means of a circulating pump which can be operated in opposite directions of rotation. During the washing mode the circulating pump is operated in a first direction of rotation and during the self-cleaning mode it is operated in the opposite direction of rotation to supply the washing liquid line with washing liquid under pressure. By means of corresponding settings of valves or water diverters, the washing liquid is then supplied under pressure to the washing liquid line through the first opening or via one open end when the circulating pump is operated in one direction of rotation and the washing liquid is supplied under pressure through the second opening or via the other end when the circulating pump is operating in the opposite direction of rotation.

According to a further preferred embodiment of the method according to the invention, the washing liquid is supplied under pressure to the washing liquid line during the self-cleaning mode by means of the circulating pump by operating the circulating pump with alternating direction of rotation. In this way, the direction of flow of the washing liquid in the washing liquid line can be arbitrarily changed during the self-cleaning mode which enhances the cleaning effect for the removal of wash residue from the washing liquid line. At the same time, corresponding settings of valves or water diverters prevent the washing liquid from entering into the spray device of the dishwasher during the self-cleaning mode so that the wash residues released from the washing liquid line cannot become deposited in he spray device.

In this case, it is particularly advantageous if the speed or the pumping capacity of the circulating pump is increased during the self-cleaning mode. By this means a correspondingly more intensive self-cleaning process can be carried out as required, i.e. depending on the degree of deposition of wash residue in the washing liquid line.

1-15. (canceled)

16. A dishwasher comprising:
at least one washing container;
a spray device for spraying washing liquid into the interior of the washing container; and
at least one washing liquid line for supplying washing liquid to the spray device, the washing liquid line including at least one first opening and a second opening at a distance from the first opening via which washing liquid can be supplied under pressure alternately through one of the openings and then through another of the openings.

17. The dishwasher according to claim 16, wherein the first opening and the second opening of the washing liquid line and two open ends of the washing liquid line and washing liquid can be supplied under pressure via the two open ends of the washing liquid line.

18. The dishwasher according to claim 16, wherein the washing liquid line has a number of openings for supplying washing liquid under pressure.

19. The dishwasher according to claim 16 and further comprising at least one water diverter that regulates the supply of washing liquid to the washing liquid line.

20. The dishwasher according to claim 19, wherein, in a first position of the water diverter, the washing liquid is supplied under pressure via the first opening of the washing liquid line and in a second position of the water diverter, the washing liquid is supplied under pressure via the second opening of the washing liquid line.

21. The dishwasher according to claim 19, wherein the water diverter is provided at the first opening of the washing liquid line and a selected one of a one water diverter and a valve is provided at the second opening of the washing liquid line that regulates the supply of washing liquid to the washing liquid line.

22. The dishwasher according to according to claim 16, wherein the washing liquid line is operable to receive washing liquid supplied thereto under varying pressures.

23. The dishwasher according to claim 16, wherein the washing liquid line is operable to receive washing liquid supplied thereto under pressure by means of a circulating pump whose speed or pumping capacity can be varied.

24. The dishwasher according to claim 16, wherein the washing liquid line is operable to receive washing liquid supplied thereto under pressure by means of a circulating pump which can be operated in opposite directions of rotation.

25. A method for operating a dishwasher comprising:
supplying washing liquid under pressure to a washing liquid line via a first opening in the washing liquid line during a washing mode of the dishwasher; and
supplying washing liquid under pressure to a washing liquid line via a second opening in the washing liquid line during a self-cleaning mode of the dishwasher.

26. The method for operating a dishwasher according to claim 25, wherein the washing liquid is supplied under pressure to the washing liquid line during the washing mode by means of a water diverter via the first opening in the washing liquid line by bringing the water diverter into a first position and the washing liquid is supplied under pressure to the washing liquid line during the self-cleaning mode via the second opening in the washing liquid line, by bringing the water diverter into a second position.

27. The method for operating a dishwasher according to claim 26, wherein the washing liquid is supplied via the water diverter in each case through the open ends of the washing liquid line, by supplying the washing liquid under pressure to the washing liquid line during the washing mode via one open end of the washing liquid line when the water diverter is in the first position and supplying the washing liquid under pressure to the washing liquid line via the other open end of the washing liquid line when the water diverter is in the second position.

28. The method for operating a dishwasher according to claim 25, wherein the washing liquid is supplied under pressure to the washing liquid line during the washing mode by means of a circulating pump which can be operated in opposite directions of rotation by operating the circulating pump in a first direction of rotation and supplying the washing liquid under pressure to the washing liquid line during the self-cleaning mode by means of a circulating pump by operating the circulating pump in an opposite direction of rotation.

29. The method for operating a dishwasher according to claim 28, wherein the washing liquid is supplied under pressure to the washing liquid line during the self-cleaning mode by means of the circulating pump by operating the circulating pump with alternating direction of rotation.

30. The method for operating a dishwasher according to claim 28, wherein the speed or the pump capacity of the circulating pump is increased during the self-cleaning mode.
